(19) United States
(12) Patent Application Publication
(10) Pub. No.: US 2026/0233680 A1
(43) Pub. Date: Aug. 13, 2026

(54) CARGO AREA UTILITY BOARD

(71) Applicant: Scout Motors Inc., Tysons, VA (US)

(72) Inventors: Lounes Gaouir, Waterford Township, MI (US); Juaquin Bryant, Farmington Hills, MI (US); Andrew Bazinski, Ferndale, MI (US); Robert Shipley, Westland, MI (US)

(21) Appl. No.: 19/052,799

(22) Filed: Feb. 13, 2025

(51) Int. Cl. B60R 7/02; B60R 5/00; B60R 11/00

(52) U.S. Cl. CPC B60R 7/02; B60R 5/003; B60R 2011/0022; B60R 2011/0036; B60R 2011/0085

(57) ABSTRACT

A utility board may include a hinge panel defining a primary hinge axis configured to be positioned adjacent a rear pillar of the vehicle and a secondary hinge axis. A utility board may include a storage panel hingedly coupled to the hinge panel and rotatable relative to the hinge panel about the secondary hinge axis. A utility board may include a strike plate configured to be coupled to the vehicle. A utility board may include a latch coupled to the storage panel and movable between an open latch position and a closed latch position. A utility board may include a latch handle coupled to the hinge panel and coupled to the latch to control the latch between the open latch position and the closed latch position.

### BACKGROUND

Vehicles have storage areas, such as rear trunks, but these storage areas often lack effective storage systems. Thus, there is a need in the art for vehicle storage systems.

### SUMMARY

In some aspects, a utility board for a vehicle includes a hinge panel defining a primary hinge axis configured to be positioned adjacent a rear pillar of the vehicle and a secondary hinge axis; a storage panel hingedly coupled to the hinge panel and rotatable relative to the hinge panel about the secondary hinge axis; a strike plate configured to be coupled to the vehicle; a latch coupled to the storage panel and movable between an open latch position and a closed latch position; and a latch handle coupled to the hinge panel and coupled to the latch to control the latch between the open latch position and the closed latch position.

In some aspects, the utility board is movable between a stowed position and a cross-body position.

In some aspects, when in the cross-body position, the storage panel extends perpendicular to a vertical plane extending parallel to a centerline of the vehicle and intersecting the primary hinge axis.

In some aspects, when in the cross-body position, the hinge panel is parallel to the storage panel.

In some aspects, the utility board is movable between a stowed position and an extended position.

In some aspects, when in the extended position, the storage panel is arranged parallel to a vertical plane extending parallel to a centerline of the vehicle and intersecting the primary hinge axis.

In some aspects, the storage panel is sized so that the storage panel at least partially extends outside a storage area of the vehicle when in the extended position.

In some aspects, the utility board defines a vertical plane extending parallel to a centerline of the vehicle and intersecting the primary hinge axis, and wherein the utility board is movable to a stowed position where the storage panel is offset from the vertical plane.

In some aspects, the storage panel is parallel to the vertical plane in the stowed position.

In some aspects, the utility board further includes a pillar bracket configured to couple to the rear pillar and hingedly couple to the hinge panel at the primary hinge axis.

In some aspects, the pillar bracket and the strike plate are coupled to an exoskeleton bracket.

In some aspects, the utility board further includes a storage rack removably coupled to the storage panel.

In some aspects, the utility board further includes a folding work surface removably coupled to the storage panel.

In some aspects, the storage panel includes a track.

In some aspects, at least one of a folding work surface and a storage rack are slidingly engaged with the track.

In some aspects, a vehicle includes: a storage area including a structural pillar adjacent a front or rear of the vehicle; a pillar bracket coupled to the structural pillar; a hinge panel coupled to the pillar bracket about a primary hinge axis, the hinge panel supporting a latch handle; and a storage panel coupled to the hinge panel about a secondary hinge axis, the storage panel supporting a latch actuated by the latch handle between an open latch position inhibiting movement of the storage panel and a closed latch position inhibiting movement of the storage panel, wherein the hinge panel and the storage panel are movable between a stowed position, a cross-body position, and an extended position.

In some aspects, a vertical plane extends parallel to a centerline of the vehicle and intersects the primary hinge axis, wherein when in the stowed position, the storage panel is offset from the vertical plane, wherein when in the cross-body position, the storage panel is arranged perpendicular to the vertical plane, and wherein when in the extended position, the storage panel is arranged parallel to the vertical plane and extending at least partially out of the storage area.

In some aspects, the storage panel includes a track, and wherein at least one of a folding work surface and a storage rack are slidingly engaged with the track.

In some aspects, a vehicle includes: a rear storage area including a rear pillar, a body structural member, and an interior facia; and a utility board including: a pillar bracket coupled to the rear pillar and extending through the interior facia, a hinge panel coupled to the pillar bracket, the hinge panel supporting a latch handle, a storage panel coupled to the hinge panel, the storage panel supporting a latch actuated by the latch handle between an open latch position inhibiting movement of the storage panel and a closed latch position inhibiting movement of the storage panel, and a strike plate coupled to the body structural member and extending through the interior facia, the strike plate sized to engage the latch.

In some aspects, a vertical plane extends parallel to a centerline of the vehicle and intersects the pillar bracket, wherein the utility board is arrangeable in a stowed position with the storage panel offset from and parallel to the vertical plane, wherein the utility board is arrangeable in a cross-body position with the storage panel arranged perpendicular to the vertical plane, and wherein the utility board is arrangeable in an extended position with the storage panel arranged parallel to the vertical plane and extending at least partially out of the rear storage area.

This summary is illustrative only and is not intended to be in any way limiting. Other aspects and advantages of the devices or processes described herein will become apparent in the detailed description set forth herein, taken in conjunction with the accompanying figures, wherein like reference numerals refer to like elements.

### BRIEF DESCRIPTION OF DRAWINGS

The methods, apparatuses, and systems of this disclosure are explained in even greater detail in the following drawings. The drawings are merely exemplary and certain features may be used singularly or in combination with other features. The drawings are not necessarily drawn to scale.

FIG. 1 is a side view of a vehicle, according to some implementations.

FIG. 2 is a perspective view of a rear cargo area of the vehicle of FIG. 1, according to some implementations.

FIG. 3 is a right side view of a cargo area utility board of the rear cargo area of FIG. 2, according to some implementations.

FIG. 4 is an exploded view of the cargo area utility board of FIG. 3, according to some implementations.

FIG. 5 is a right side view of the cargo area of FIG. 2 with the cargo area utility board in a stowed position, according to some implementations.

FIG. 6 is a top view of the cargo area utility board in the stowed position, according to some implementations.

FIG. 7 is a perspective view of the cargo area of FIG. 2 with the cargo area utility board in a cross-body position, according to some implementations.

FIG. 8 is a top view of the cargo area utility board in the cross-body position, according to some implementations.

FIG. 9 is a perspective view of the cargo area of FIG. 2 with the cargo area utility board in an extended position, according to some implementations.

FIG. 10 is a top view of the cargo area utility board in the extended position, according to some implementations.

FIG. 11 is a top view of another cargo area utility board in a slide access position, according to some implementations.

FIG. 12 is a top view of another cargo area utility board in a slide access position, according to some implementations.

FIG. 13 is a top view of another cargo area including two cargo area utility boards, according to some implementations.

FIG. 14 is a top view of the cargo area utility board of FIG. 3 in the extended position and including a table, according to some implementations.

FIG. 15 is a right side view of a frame hinge and strike plate of the cargo area utility board of FIG. 3, according to some implementations.

FIG. 16 is a right side view of an exoskeleton for supporting a cargo area utility board, according to some implementations.

FIG. 17 is a perspective view of a gear rack that can be used with the cargo area utility board of FIG. 3, according to some implementations.

FIG. 18 is a sectional view of the gear rack of FIG. 17 taken along line 18-18, according to some implementations.

FIGS. 19-21 are perspective views of alternate mounting locations of a cargo area utility board, according to some implementations.

### DETAILED DESCRIPTION

Following below are more detailed descriptions of concepts related to, and implementations of, methods, apparatuses, and systems for vehicle storage. The figures illustrate exemplary implementations in detail and the present disclosure is not limited to the details or methodology set forth in the description or illustrated in the figures. The terminology used herein is for the purpose of description only and should not be regarded as limiting.

Referring to the figures generally, the various implementations disclosed herein relate to systems, apparatuses, and methods for providing a storage solution for a vehicle. In particular, a cargo area utility board can be provided in a rear storage area of the vehicle that allows for a swing out interior storage panel. The cargo area utility board includes a bracket coupled to (e.g., fastened to) a rearmost pillar (e.g., D-pillar) area in the rear storage area, wherein a hinge is coupled to the cargo area utility board to rotate around the hinge between a stowed position (e.g., a 0° position), a cross-body position (e.g., a 90° position), and an extended position (e.g., a 180° position) to allow a user to easily load or remove items from the cargo area utility board. The cargo area utility board can be locked in the stowed position using a release handle near or adjacent a rear door to the rear storage area to robustly secure the board. In some implementations, the release handle is positioned near the rear pillar to allow the user to unlock the cargo area utility board from there and allow the board to move towards them. In some implementations, the cargo area utility board can be locked in the cross-body position to allow the board to be used as a back rest or improved access to stored goods. In some implementations, the cargo area utility board is installed on both sides of the vehicle to provide more storage and/or full coverage as a back rest if needed. In some implementations, a table can be coupled to the cargo area utility board to provide the user with a working area for multiple purposes. In some implementations, the cargo area utility board includes retention features so it can be easily removable. In some implementations, the cargo area utility board can be installed in a front storage area (e.g., a frunk) of the vehicle. In some implementations, the cargo area utility board includes a storage rack that can be attached to the board, removed, and stored in another location.

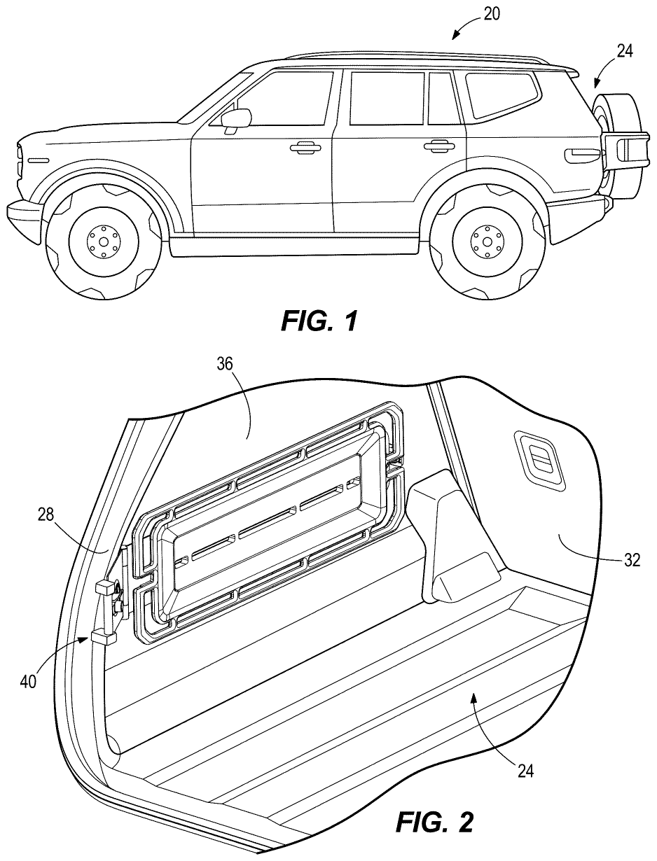

As shown in FIG. 1, a vehicle 20 in the form of a sport utility vehicle includes a storage area in the form of a rear storage area 24. In some implementations, the vehicle 20 is a truck, a van, a passenger car, or another type of vehicle. In some implementations, the storage area is in a different part of the vehicle 20, such as a front storage area (i.e., a frunk) when the vehicle 20 is a battery electric vehicle.

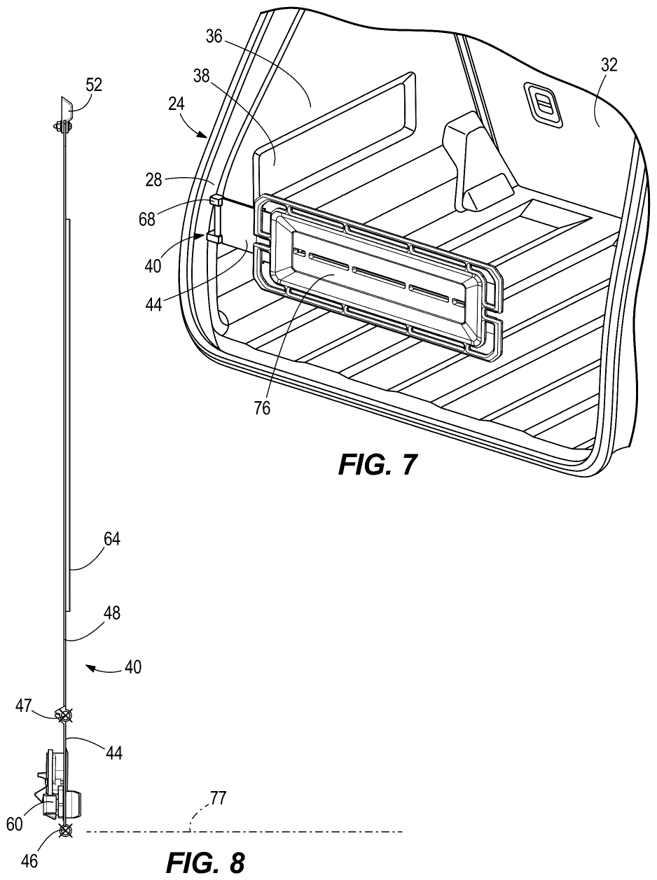

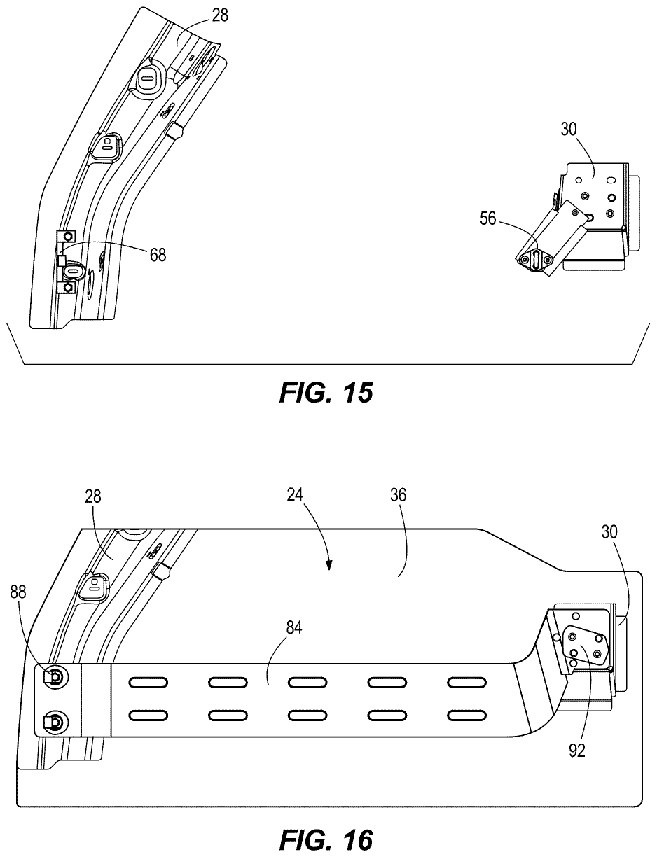

As shown in FIG. 2, the rear storage area 24 is defined between a rear pillar 28 (e.g., a D-pillar of a sport utility vehicle) and a rear seat 32. The rear pillar 28 is a structural member of the vehicle 20. The rear storage area 24 also includes a body structural member 30 (see FIG. 15). An interior facia 36 covers a wall area of the rear storage area 24. In some implementations, the interior facia 36 includes a storage cavity 38 (see FIG. 7). In some implementations, the interior facia 36 is formed of plastic. A utility board 40 is installed in the rear storage area 24.

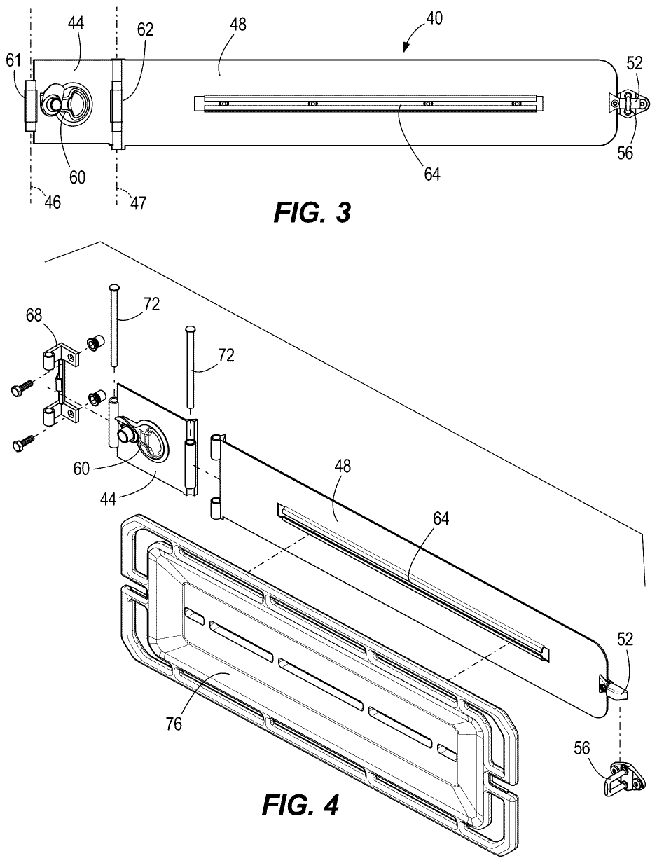

As shown in FIG. 3, the utility board 40 includes a hinge panel 44 defining a primary hinge axis 46 and a secondary hinge axis 47. A storage panel 48 is connected to the hinge panel 44 and rotatable relative thereto about the secondary hinge axis 47. A latch 52 is connected to the storage panel 48 and sized to engage a strike plate 56 mounted to the interior facia 36. A latch handle 60 is mounted to the hinge panel 44 and connected (e.g., mechanically, electrically, wirelessly, etc.) to the latch 52 to control actuation of the latch 52 between an open latch position allowing disengagement of the latch 52 from the strike plate 56 and a closed latch position inhibiting disengagement of the latch 52 from the strike plate 56. In some implementations, the hinge panel 44 includes a primary hinge actuator 61 that selectively allows or inhibits rotation of the hinge panel 44 about the primary hinge axis 46. The primary hinge actuator 61 can include a latching mechanism structured to lock the hinge panel 44 in preselected positions relative to the rear pillar 28. In some implementations, the hinge panel 44 includes a secondary hinge actuator 62 that selectively allows or inhibits rotation of the hinge panel 44 about the secondary hinge axis 47. The secondary hinge actuator 62 can include a latching mechanism structured to lock the hinge panel 44 in preselected positions relative to the storage panel 48. The storage panel 48 also includes a track 64 extending along a length of the storage panel 48. In some implementations, the track 64 is raised at least partially above a panel plane of the storage panel 48 to allow accessories (e.g., a storage rack 76) along the track 64. In some implementations, the track 64 is sunk into or recessed within the storage panel 48. In some implementations, the track 64 is coplanar with the storage panel 48.

As shown in FIG. 4, a pillar bracket 68 is shaped to be fastened to the rear pillar 28 and connected to the hinge panel 44 with a hinge pin 72 at the primary hinge axis 46. A second hinge pin 72 connects the hinge panel 44 and the storage panel 48 at the secondary hinge axis 47. A storage rack 76 can be connected to the storage panel 48 via the track 64. In some implementations, the storage rack 76 is connected to the track 64 by sliding the storage rack 76 into the track 64 from either end.

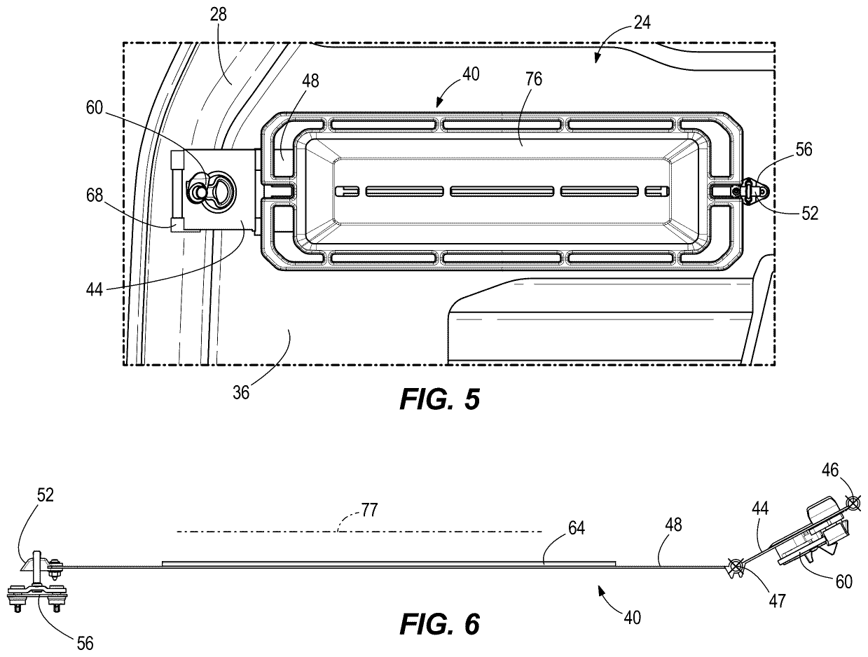

As shown in FIGS. 5 and 6, the utility board 40 is arranged in the stowed position. In some implementations, the storage panel 48 is at least partially received in the storage cavity 38 of the interior facia 36 when the utility board 40 is arranged in the stowed position. In the stowed position, the storage panel 48 is offset from and parallel to a vertical plane 77 that intersects the primary hinge axis 46 and extends parallel to a centerline of the vehicle 20. This offset allows the utility board 40 to be stored within the rear storage area 24 without taking up space that could be used for other storage. In the stowed position, the latch 52 is engaged with the strike plate 56 to maintain the utility board 40 in the stowed position. In some implementations, the hinge panel 44 and the storage panel 48 are formed as a single piece so that the hinge coupling between the hinge panel 44 and the storage panel 48 is eliminated and the storage panel 48 is arranged relative to the hinge panel 44 as shown in FIG. 6 (e.g., at an angle that allows the utility board 40 to be held in the stowed position with the storage panel 48 offset form the vertical plane 77). When the hinge coupling between the hinge panel 44 and the storage panel 48 is eliminated, the hinge panel 44 and the storage panel 48 are fixed at an oblique angle relative to one another and the hinge panel 44 does not rotate relative to the storage panel 48.

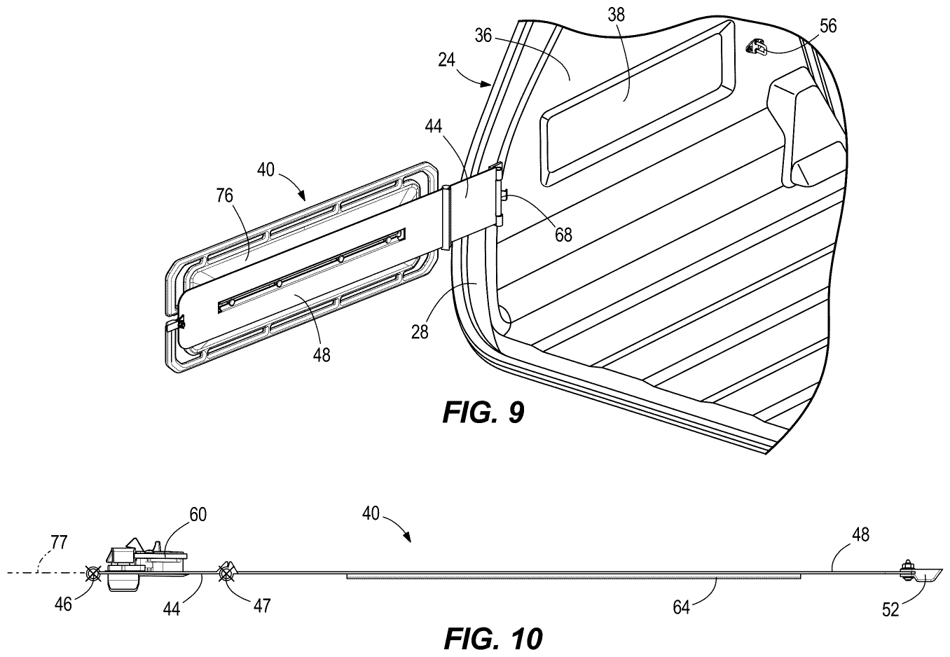

As shown in FIGS. 7 and 8, the utility board 40 is moved into the cross-body position (e.g., the 90° position, perpendicular to the vertical plane 77) by engaging the latch handle 60, which releases the latch 52, the primary hinge actuator 61, and secondary hinge actuator 62. Releasing the latch 52, primary hinge actuator 61, and secondary hinge actuator 62 allows the storage panel 48 to rotate into alignment with the hinge panel 44 and allows the hinge panel 44 to rotate about the primary hinge axis 46 until the hinge panel 44 is arranged at a cross-body angle (e.g., the 90° position) relative to the vertical plane 77. When the latch handle 60 is released, the latch handle 60 is engaged and the utility board 40 is locked in the cross-body position. In the cross-body position, the utility board 40 can be used as a backrest. In some implementations, a back cushion can be attached to the storage panel 48 to improve comfort while the utility board 40 is used as a backrest.

As shown in FIGS. 9 and 10, the utility board 40 is moved into the extended position (e.g., the 180° position) by engaging the latch handle 60, which releases the primary hinge actuator 61 and secondary hinge actuator 62. Releasing the primary hinge actuator 61 and secondary hinge actuator 62 allows the storage panel 48 to rotate about the primary hinge axis 46 until the hinge panel 44 is arranged at an extended angle (e.g., 180°, parallel to the 0° position) relative to the vertical plane 77 and at least partially outside of the cargo area 24. The extended position can be used to load stored items onto the storage panel 48 more easily or to provide access to stored items outside the vehicle 20, for example.

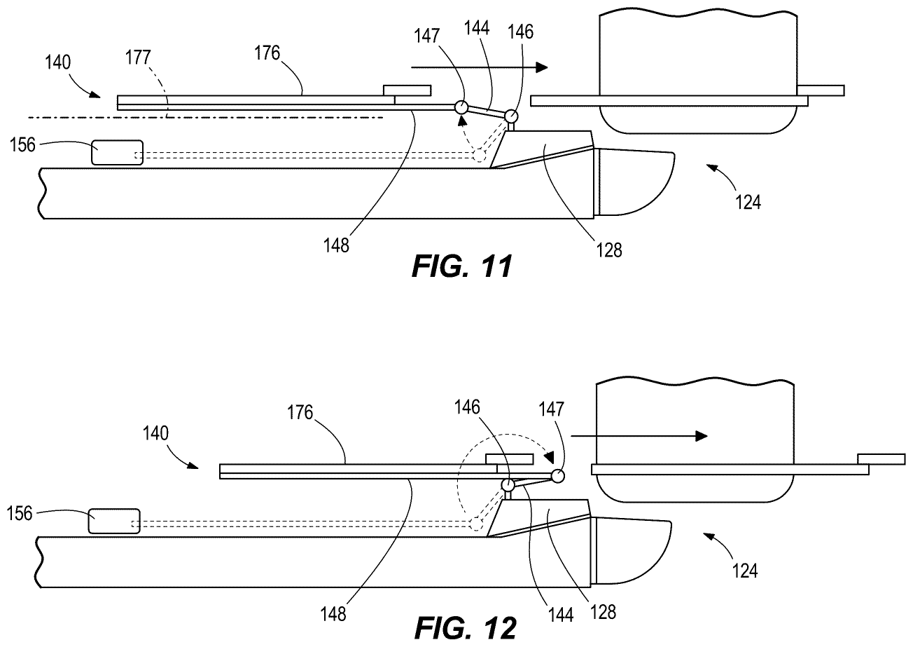

FIGS. 11 and 12 show a utility board 140 according to another implementation. The implementation of the utility board 140 is similar to the utility board 40 described herein and includes like parts numbered in the 100 series. The utility board 140 is movable between a stowed position, similar to the stowed position of the utility board 40, and an access position, wherein the storage rack 176 is spaced apart from the interior facia 36, which allows the storage rack 176 to be removed from the storage panel 148. As shown in FIG. 11, the access position is reached by rotating the hinge panel 144 and the storage panel 148 about the primary hinge axis 146 and the secondary hinge axis 147 so that the storage panel 148 is disposed outside of the rear pillar 128 of the rear storage area 124 and the vertical plane 177. As shown in FIG. 12, the access position is reached by rotating the hinge panel 144 and the storage panel 148 about the primary hinge axis 146 and the secondary hinge axis 147 so that the storage panel 148 contacts or nearly contacts the hinge panel 144 and a portion of the storage panel 148 is brought rearward of the primary hinge axis 146. The arrangement shown in FIG. 12 may provide easier access to the storage panel 148 for a user compared to the arrangement of FIG. 11.

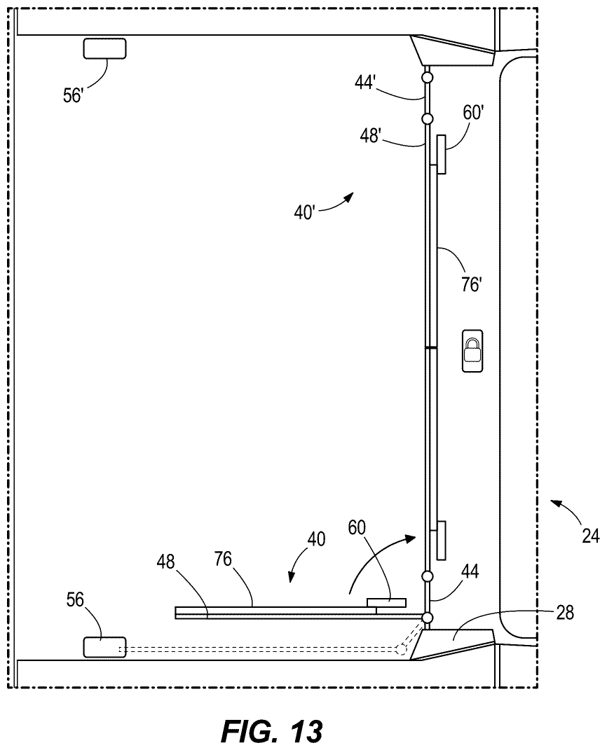

As shown in FIG. 13, the rear storage area 24 can include a second utility board 40′ arranged on an opposite side of the vehicle 20. The utility board 40′ is a mirror of the utility board 40. In some implementations, the utility board 40 defines the same length toward a center of the vehicle 20 as the utility board 40′. In some implementations, a length of the utility board 40 is different than a length of the utility board 40′. In some implementations, the utility board 40 can be locked to the utility board 40′ when they are both arranged in the cross-body position.

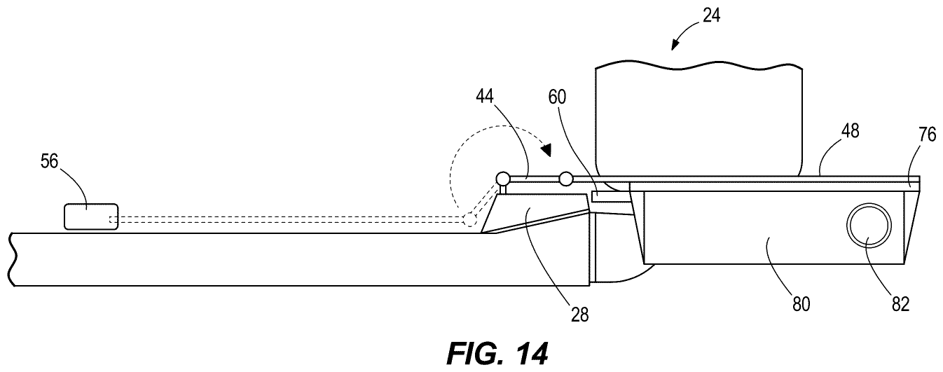

As shown in FIG. 14, a folding table or work surface 80 can be attached to the storage panel 48 (e.g., via the track 64) and may be folded down (e.g., the stowed position, the cross-body position, or the extended position). In some implementations, the work surface 80 includes a cup or bottle holder 82. In some implementations, the work surface 80 can include other organizational features such as a pencil tray, a parts holder, a phone stand, etc.

As shown in FIG. 15, in some implementations, the strike plate 56 is mounted to the body structural member 30 and the pillar bracket 68 is mounted to the rear pillar 28 beneath the interior facia 36. In some implementations, the interior facia 36 may include removable access panels aligned with the pillar bracket 68 and the strike plate 56 so that should a user desire to add the utility board 40, 140, 40′ to their vehicle 20 after purchase, the same interior facia 36 can be used both with and without the utility board 40, 140, 40′.

As shown in FIG. 16, an exoskeleton bracket 84 can be connected to the rear pillar 28 and the body structural member 30 over the interior facia 36 so that the utility board 40, 140, 40′ can be added to the vehicle 20 with minimal modification of the interior facia 36. The exoskeleton bracket 84 includes an exoskeleton pillar bracket 88 that is similar to the pillar bracket 68 discussed above and an exoskeleton strike plate 92 that is similar to the strike plate 56 discussed above.

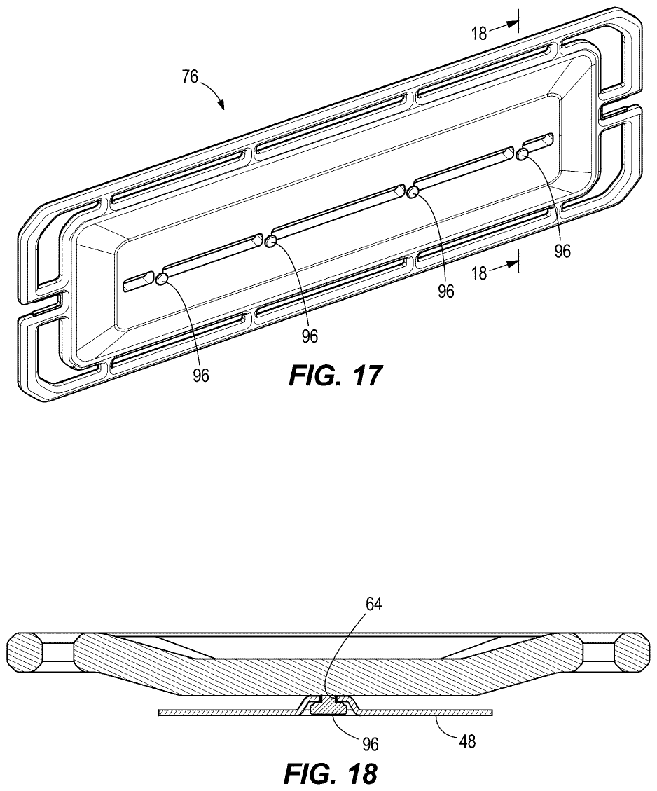

As shown in FIGS. 17 and 18, the storage rack 76 includes four pins or roller wheels 96 extending from a back surface of the storage rack 76 that are sized to be received within the track 64 of the storage panel 48. The roller wheels 96 allow the storage rack 76 to be slid easily onto and off of the storage panel 48. The storage rack 76 is designed to hold a large variety of accessories and can be conveniently stored outside the vehicle 20 and loaded into the vehicle 20 when desired. For example, a user may possess a number of storage racks 76 loaded with different items, and move a desired storage rack 76 into the vehicle 20 for a specific purpose. This broadens the usefulness of the utility board 40, 140, 40′ as a storage solution.

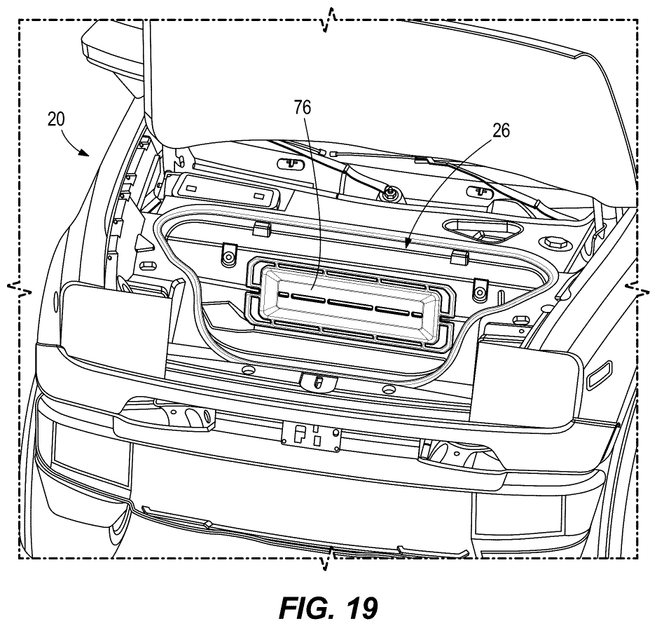

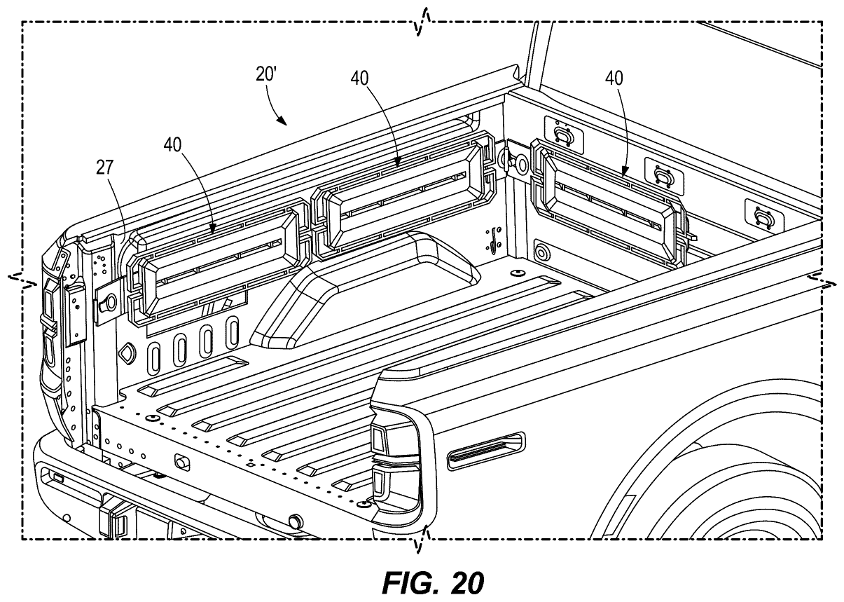

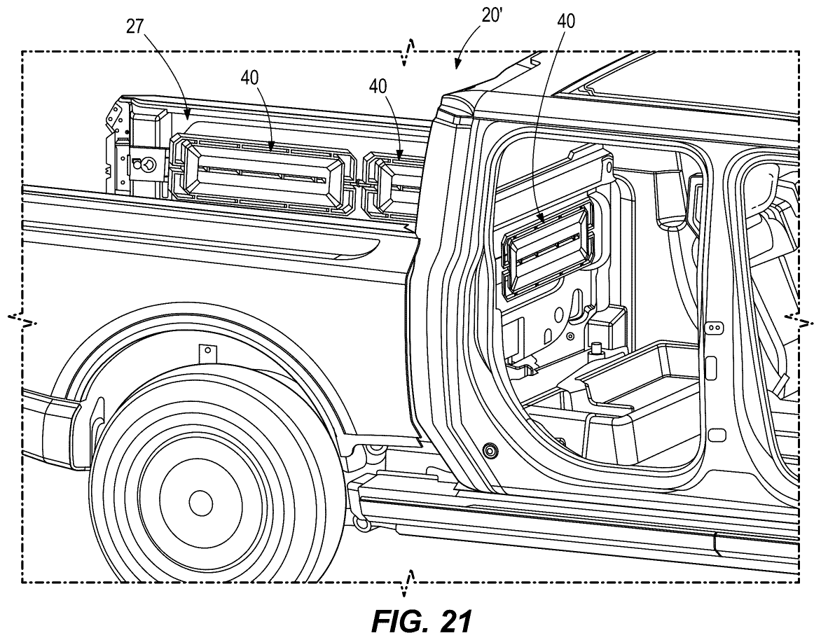

As shown in FIGS. 19-21, one or more utility boards 40 can be positioned in different parts of the vehicle 20. Additionally, the storage rack 76 can be stored in different parts of the vehicle 20 to provide a complimentary storage system. For example, FIG. 19 shows a storage rack 76 stored in a frunk or front storage area of the vehicle 20. In some implementations, the storage rack 76 could be moved from the frunk to the utility board 40 in the rear storage area 24 and vice versa. As shown in FIG. 20, three utility boards 40 can be installed in the bed of a pickup truck or other vehicle. In some implementations, more than three or less than three utility boards 40. In some implementations, a single utility board 40 can be positioned in any of the positions shown in FIG. 20 or in other positions of the vehicle. The pillar bracket 68 and the strike plate 56 can be mounted to the pickup bed to support the utility board 40 during use. For example, the pillar bracket 68 can be coupled to the bed frame adjacent the tailgate, and the strike plate 56 can be fastened to the interior side face of the bed. As shown in FIG. 21, a utility board 40 and/or a storage rack 76 can be positioned within the cab of a vehicle (e.g., a pickup truck).

For purposes of this description, certain advantages and novel features of the aspects and configurations of this disclosure are described herein. The described methods, systems, and apparatus should not be construed as limiting in any way. Instead, the present disclosure is directed toward all novel and nonobvious features and aspects of the various disclosed aspects, alone and in various combinations and sub-combinations with one another. The disclosed methods, systems, and apparatus are not limited to any specific aspect, feature, or combination thereof, nor do the disclosed methods, systems, and apparatus require that any one or more specific advantages be present or problems be solved.

Although the figures and description may illustrate a specific order of method steps, the order of such steps may differ from what is depicted and described, unless specified differently above. Also, two or more steps may be performed concurrently or with partial concurrence, unless specified differently above. All such variations are within the scope of the disclosure.

Features disclosed in this specification (including any accompanying claims, abstract, and drawings), and/or all of the steps of any method or process so disclosed, may be combined in any combination, except combinations where at least some of such features and/or steps are mutually exclusive. The claimed features extend to any novel one, or any novel combination, of the features disclosed in this specification (including any accompanying claims, abstract, and drawings), or to any novel one, or any novel combination, of the steps of any method or process so disclosed.

The terms “coupled”, “connected”, and the like as used herein mean that two members are joined together, directly or indirectly. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

Certain terminology is used in the following description for convenience only and is not limiting. The words “right”, “left”, “lower”, “upper”, “front”, “rear”, “forward”, and “rearward” designate direction in the drawings to which reference is made. For example, a forward direction may be in the direction of forward travel of a vehicle. The words “inner” and “outer” refer to directions toward and away from, respectively, the geometric center of the described feature or device. The terminology includes the above-listed words, derivatives thereof, and words of similar import.

Throughout the description and claims of this specification, the word “comprise” and variations of the word, such as “comprising” and “comprises”, means “including but not limited to”, and is not intended to exclude, for example, other additives, components, integers or steps. “Exemplary” means “an example of” and is not intended to convey an indication of a preferred or ideal aspect. “Such as” is not used in a restrictive sense, but for explanatory purposes.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the form disclosed. Many modifications and variations will be apparent to those of ordinary skill in the art without departing from the scope and spirit of the present disclosure.

What is claimed is:

1. A utility board for a vehicle, the utility board comprising:
a hinge panel defining a primary hinge axis and a secondary hinge axis, wherein the primary hinge axis is configured to be positioned adjacent a rear pillar of the vehicle;
a storage panel hingedly coupled to the hinge panel and rotatable relative to the hinge panel about the secondary hinge axis;
a strike plate configured to be coupled to the vehicle;
a latch coupled to the storage panel and movable between an open latch position and a closed latch position; and
a latch handle coupled to the hinge panel and coupled to the latch to control the latch between the open latch position and the closed latch position.

2. The utility board of claim 1, wherein the utility board is movable between a stowed position and a cross-body position.

3. The utility board of claim 2, wherein when in the cross-body position, the storage panel extends perpendicular to a vertical plane extending parallel to a centerline of the vehicle and intersecting the primary hinge axis.

4. The utility board of claim 2, wherein when in the cross-body position, the hinge panel is parallel to the storage panel.

5. The utility board of claim 1, wherein the utility board is movable between a stowed position and an extended position.

6. The utility board of claim 5, wherein when in the extended position, the storage panel is arranged parallel to a vertical plane extending parallel to a centerline of the vehicle and intersecting the primary hinge axis.

7. The utility board of claim 6, wherein the storage panel is sized so that the storage panel at least partially extends outside a storage area of the vehicle when in the extended position.

8. The utility board of claim 1, wherein the utility board defines a vertical plane extending parallel to a centerline of the vehicle and intersecting the primary hinge axis, and
wherein the utility board is movable to a stowed position where the storage panel is offset from the vertical plane.

9. The utility board of claim 8, wherein the storage panel is parallel to the vertical plane in the stowed position.

10. The utility board of claim 1, further comprising a pillar bracket configured to couple to the rear pillar and hingedly couple to the hinge panel at the primary hinge axis.

11. The utility board of claim 10, wherein the pillar bracket and the strike plate are coupled to an exoskeleton bracket.

12. The utility board of claim 1, further comprising a storage rack removably coupled to the storage panel.

13. The utility board of claim 1, further comprising a folding work surface removably coupled to the storage panel.

14. The utility board of claim 1, wherein the storage panel includes a track.

15. The utility board of claim 14, wherein at least one of a folding work surface and a storage rack are slidingly engaged with the track.

16. A vehicle comprising:
a storage area including a structural pillar adjacent a front or rear of the vehicle;
a pillar bracket coupled to the structural pillar;
a hinge panel coupled to the pillar bracket about a primary hinge axis, the hinge panel supporting a latch handle; and
a storage panel coupled to the hinge panel about a secondary hinge axis, the storage panel supporting a latch actuated by the latch handle between an open latch position inhibiting movement of the storage panel and a closed latch position inhibiting movement of the storage panel,
wherein the hinge panel and the storage panel are movable between a stowed position, a cross-body position, and an extended position.

17. The vehicle of claim 16, wherein a vertical plane extends parallel to a centerline of the vehicle and intersects the primary hinge axis,
wherein when in the stowed position, the storage panel is offset from the vertical plane,
wherein when in the cross-body position, the storage panel is arranged perpendicular to the vertical plane, and
wherein when in the extended position, the storage panel is arranged parallel to the vertical plane and extending at least partially out of the storage area.

18. The vehicle of claim 16, wherein the storage panel includes a track, and
wherein at least one of a folding work surface and a storage rack are slidingly engaged with the track.

19. A vehicle comprising:
a rear storage area including a rear pillar, a body structural member, and an interior facia; and
a utility board including:
a pillar bracket coupled to the rear pillar and extending through the interior facia,
a hinge panel coupled to the pillar bracket, the hinge panel supporting a latch handle,
a storage panel coupled to the hinge panel, the storage panel supporting a latch actuated by the latch handle between an open latch position inhibiting movement of the storage panel and a closed latch position inhibiting movement of the storage panel, and
a strike plate coupled to the body structural member and extending through the interior facia, the strike plate sized to engage the latch.

20. The vehicle of claim 19, wherein a vertical plane extends parallel to a centerline of the vehicle and intersects the pillar bracket,
wherein the utility board is arrangeable in a stowed position with the storage panel offset from and parallel to the vertical plane,
wherein the utility board is arrangeable in a cross-body position with the storage panel arranged perpendicular to the vertical plane, and
wherein the utility board is arrangeable in an extended position with the storage panel arranged parallel to the vertical plane and extending at least partially out of the rear storage area.
